(19) United States
(12) Patent Application Publication
(10) Pub. No.: US 2022/0018378 A1
(43) Pub. Date: Jan. 20, 2022

(54) FLANGE BOLTING METHOD AND APPARATUS

(71) Applicant: Applied Bolting Technology, Bellows Falls, VT (US)

(72) Inventors: Jordan David Richardson, Bellows Falls, VT (US); Ivan Wayne Wallace, Bellows Falls, VT (US)

(21) Appl. No.: 17/420,852

(22) PCT Filed: Jan. 6, 2020
(86) PCT No.: PCT/US2020/012334

§ 371 Date: Jul. 6, 2021

Related U.S. Application Data
(60) Provisional application No. 62/789,732, filed on Jan. 8, 2019.

(51) Int. Cl. F16B 31/02; G01L 5/24

(52) U.S. Cl. CPC F16B 31/028; F16B 2200/506; G01L 5/243

(57) ABSTRACT

A method of loading bolts of a bolted flange connection includes obtaining an initial bolt load value for each of the bolts; loading each of the bolts, in sequence, to a respective initial bolt load value; wherein each of the bolts achieves a resultant bolt load value that meets a predetermined bolt load value.

### BACKGROUND

Embodiments described herein relate generally to direct tension indicating apparatus, and more particularly, to a direct tension indicating apparatus including a direct tension indicating washer and a base washer.

Direct tension indicating washers are used to indicate when proper bolt tension has been reached. U.S. Pat. No. 5,931,618, the entire contents of which are incorporated herein by reference, discloses an exemplary direct tension indicating washer. FIG. 1 is a top view of the direct tension indicating washer from U.S. Pat. No. 5,931,618. FIG. 2 is a cross-sectional view taken along line 2-2 of FIG. 1. Direct tension indicating washer 60 includes protuberances 12 formed on a first surface 14 and corresponding indentations 16 formed on a second surface 18. The direct tension indicating washer 60 includes channels 62 in bottom surface 18 that lead from each indentation 16 to the outer diameter of the direct tension indicating washer 60. The indentation 16 is filled with an indicating material 64. When direct tension indicating washer 60 is used with a bolt, protuberances 12 are compressed as the bolt is tensioned. When the desired bolt tension is achieved, indicating material 64 emerges from channel 62 at the outer diameter of direct tension indicating washer 60. The emission of the indicating material provides a visual indicator that the bolt has been properly tensioned.

In some installation environments, the installation surface adjacent to the second surface 18 may be rough, worn, pocked, etc. For example, a mounting flange for joining two pipes may have an irregular surface due to the lack for any tolerance control on the surface and/or repeated assembly/disassembly of the pipes. When the direct tension indicating washer 60 is used on such a surface, the indicating material may become smudged or smeared, rather than emit cleanly from the outer diameter of the direct tension indicating washer 60.

### BRIEF DESCRIPTION OF THE DRAWINGS

Referring now to the drawings wherein like elements are numbered alike in the several Figures:

FIG. 1 is a top view of a conventional direct tension indicating washer;

FIG. 2 is a cross-sectional view of the direct tension indicating washer shown in FIG. 1 taken along line 2-2; and

FIGS. 3 and 4 are perspective views of a direct tension indicating washer in an embodiment;

FIGS. 5 and 6 are perspective views of a base washer in an embodiment;

FIGS. 7 and 8 are perspective views of a direct tension indicating apparatus in an embodiment;

FIG. 9 depicts a bolted flange connection in an example embodiment;

FIG. 10 depicts a method of loading bolts in a bolted flange connection in an example embodiment.

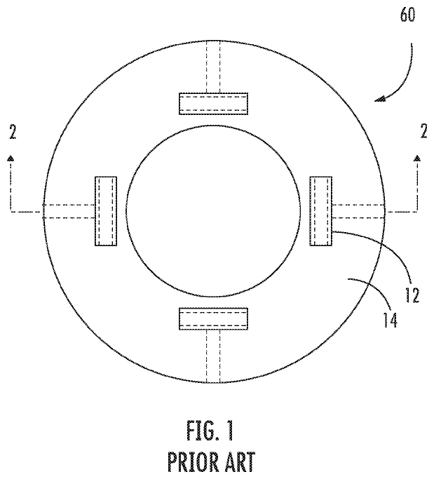

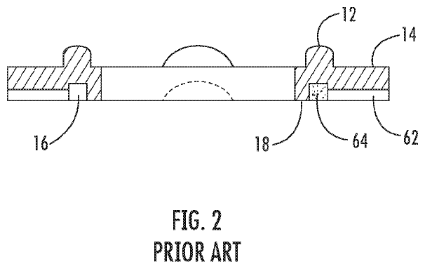

### DETAILED DESCRIPTION

Exemplary embodiments are directed to a direct tension indicating apparatus having a direct tension indicating washer and a base washer. In some embodiments, the base washer is a direct tension indicating washer. An anti-rotation feature is used to prevent rotation of the direct tension indicating washer relative to the base washer.

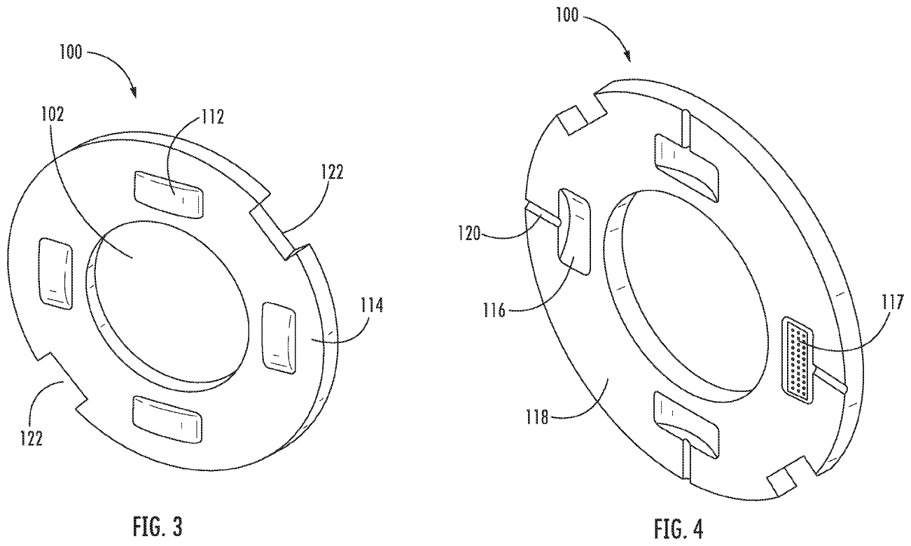

FIGS. 3 and 4 are perspective views of a direct tension indicating washer 100 in an embodiment. The direct tension indicating washer 100 has a planar body with a central opening 102. The direct tension indicating washer 100 includes protuberances 112 formed on a first surface 114 and corresponding indentations 116 formed on a second surface 118. The direct tension indicating washer 100 includes channels 120 in bottom surface 118 that lead from each indentation 116 to the outer diameter of the direct tension indicating washer 100. Each indentation 116 is filled with an indicating material 117. The indicating material 117 may be silicon or other resilient material. When direct tension indicating washer 100 is used with a bolt, protuberances 112 are compressed as the bolt is tensioned. When the desired bolt tension is achieved, indicating material 117 emerges from channel 120 at the outer diameter of direct tension indicating washer 100. The emission of the indicating material 117 provides a visual indicator that the bolt has been properly tensioned.

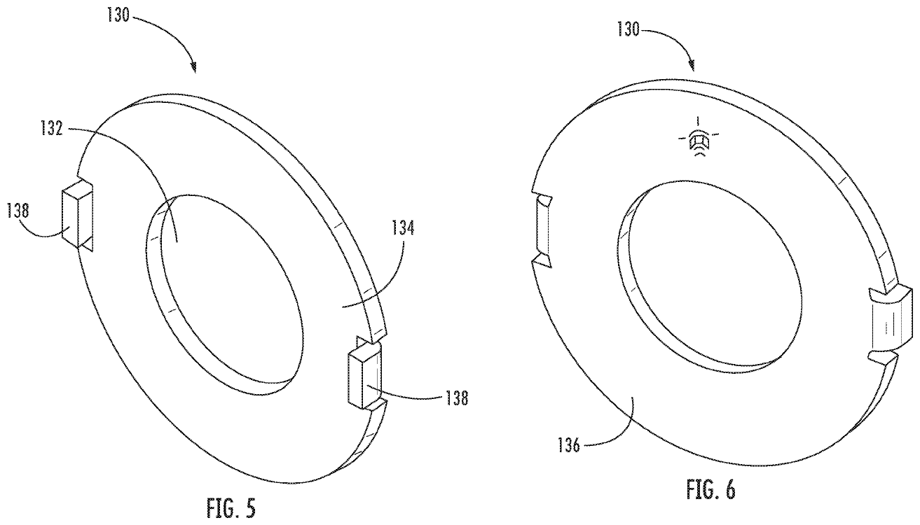

The direct tension indicating washer 100 may be used with a base washer 130, an example of which is shown in FIGS. 5 and 6. The base washer 130 has a planar body with a central opening 132, which is aligned with central opening 102 when used with direct tension indicating washer 100. The base washer 130 has a first surface 134 and a second surface 136. In use, the first surface 134 faces second surface 118 of the direct tension indicating washer 100. The direct tension indicating washer 100 and the base washer 130 are used together so that the indentations 116 are positioned above the flat, first surface 134 of the base washer 130. The first surface 134 surrounds the indentation 116, and prevents indicating material 117 from traveling in directions other than along channel 120.

The direct tension indicating washer 100 and base washer 130 include an anti-rotation feature to prevent the direct tension indicating washer 100 from rotating relative to the base washer 130. In the embodiment of FIGS. 3-6, the direct tension indicating washer 100 includes two notches 122 and base washer 130 includes two tabs 138. When used together, the tabs 138 are received in the notches 122 to prevent the base washer 130 from rotating relative to the direct tension indicating washer 100 when the nut is tightened. This prevents the indicating from smearing between the base washer 130 and direct tension indicating washer 100. Embodiments are not limited to use of two tabs 138 and two notches 122. One or more tabs 138 may be located on the direct tension indicating washer 100 and one or more notches maybe located on the base washer 130, and vice versa. The tabs 138 and notches 122 are just one example of an anti-rotation feature. In other embodiments, pins and holes are used to prevent the base washer 130 from rotating relative to the direct tension indicating washer 100.

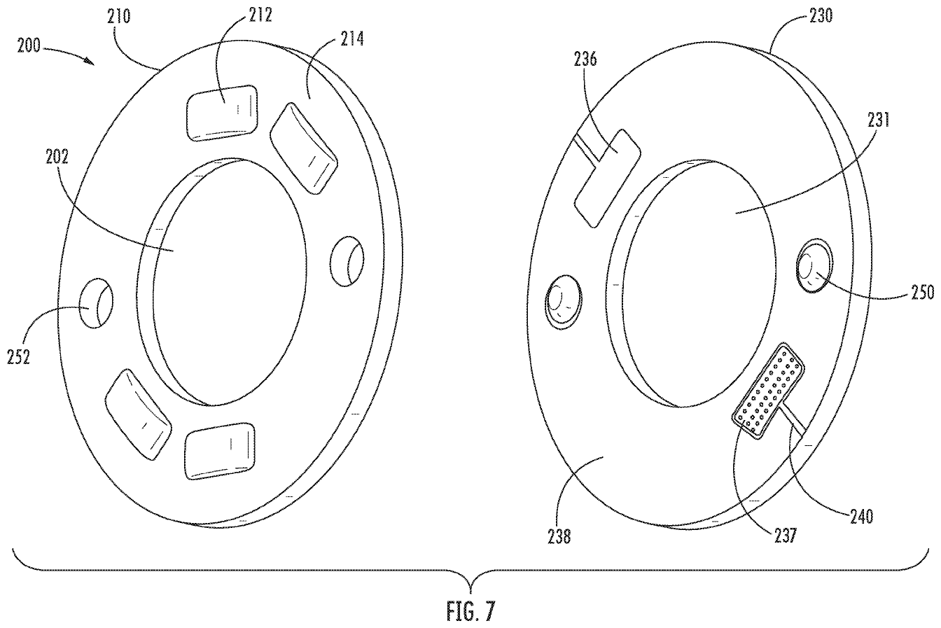

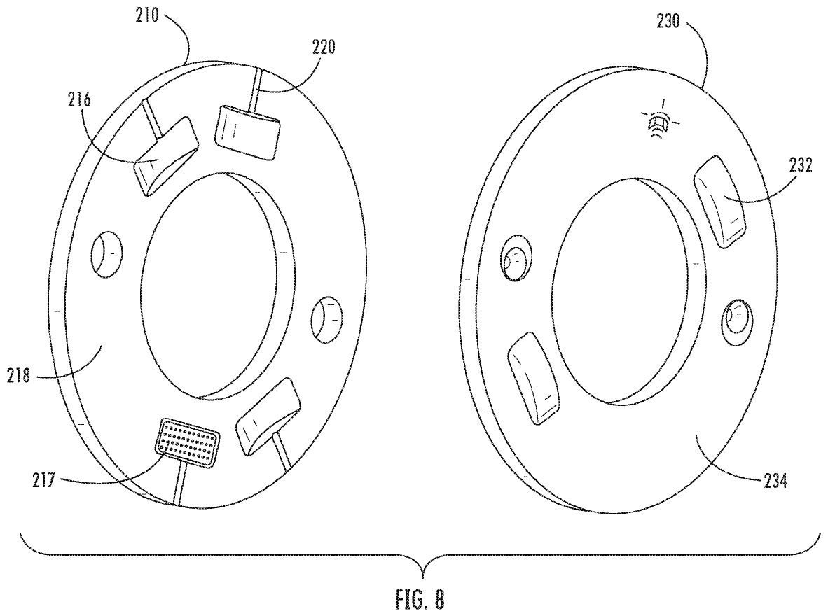

FIGS. 7 and 8 are perspective views of a direct tension indicating apparatus 200 in another embodiment. The direct tension indicating apparatus 200 includes a direct tension indicating washer 210 and a base washer 230. The direct tension indicating washer 210 has a planar body with a central opening 202. The direct tension indicating washer 210 includes protuberances 212 formed on a first surface 214 and corresponding indentations 216 formed on a second surface 218 (FIG. 8). The direct tension indicating washer 210 includes channels 220 in second surface 218 that lead from each indentation 216 to the outer diameter of the direct tension indicating washer 210. Each indentation 216 is filled with an indicating material 217. The indicating material 217 may be silicon or other resilient material. When direct tension indicating washer 210 is used with a bolt, protuberances 112 are compressed as the bolt is tensioned. When the desired bolt tension is achieved, indicating material 217 emerges from channel 220 at the outer diameter of direct tension indicating washer 210. The emission of the indicating material 217 provides a visual indicator that a predetermined bolt tension has been achieved.

In the embodiment of FIGS. 7 and 8, the base washer 230 is also a direct tension indicating washer. The direct tension indicating washer 230 has a planar body with a central opening 231. The direct tension indicating washer 230 includes protuberances 232 formed on a first surface 234 and corresponding indentations 236 formed on a second surface 238 (FIG. 7). The direct tension indicating washer 230 includes channels 240 in second surface 238 that lead from each indentation 236 to the outer diameter of the direct tension indicating washer 230. Each indentation 236 is filled with an indicating material 237. The indicating material 237 may be silicon or other resilient material. When direct tension indicating washer 230 is used with a bolt, protuberances 232 are compressed as the bolt is tensioned. When the desired bolt tension is achieved, indicating material 237 emerges from channel 240 at the outer diameter of direct tension indicating washer 230. The emission of the indicating material 237 provides a visual indicator that the bolt has been properly tensioned.

When used together as a direct tension indicating apparatus, first direct tension indicating washer 210 is placed against the second direct tension indicating washer 230 such that second surface 218 faces second surface 238. The first direct tension indicating washer 210 and the second direct tension indicating washer 230 include an anti-rotation feature in the form of pins 250 on the second surface 238 of the second direct tension indicating washer 230 and openings 252 in the planar body of the first direct tension indicating washer 210. The pins 250 engage openings 252 to prevent the second direct tension indicating washer 230 from rotating relative to the first direct tension indicating washer 210 as the bolt is tensioned.. Embodiments are not limited to use of two pins 250 and two openings 252. One or more pins 250 may be located on the direct tension indicating washer 210 and one or more openings 252 may be located on the direct tension indicating washer 230, and vice versa.

The direct tension indicating apparatus 200 of FIGS. 7 and 8 may be used in multiple manners. In a first configuration, the indentations 216 of the first direct tension indicating washer 210 are not aligned with the indentations 236 of the second direct tension indicating washer 230. This arrangement allows for indicating material 217 to be emitted at a first bolt tension and indicating material 237 to be emitted at a second bolt tension. For example, the first direct tension indicating washer 210 may be calibrated to emit the indicating material 217 at the outer diameter at a tension representing 45 ksi bolt stress, while the second direct tension indicating washer 230 may be calibrated to emit the indicating material 237 at the outer diameter at a tension representing 60 ksi bolt stress.

In an alternate configuration, the indentations 216 of the first direct tension indicating washer 210 are aligned with the indentations 236 of the second direct tension indicating washer 230. Aligning the indentations 216 with the indentations 236 results in more indicating material 217 and 237 being emitted at the outer diameter at the predetermined bolt tension, providing a higher visibility squirt event.

As noted above, the direct tension indicating washer 100 and the base washer 130 may be useful in installations where hole size, condition, and surface condition under the base washer 130 are inconsistent. Such variable hole condition and surface condition are often found in circular, bolted flange connections in pressure-stress systems, such as are typically used in piping flange connections in process :industrial plants, refineries, pipelines, etc. The bolted flange connections in such systems are occasionally made in new construction, but more frequently are encountered in maintenance situations where crews of workers are required to disassemble and reassemble such bolted flange connections under severe time constraints, and where the reassembled bolted flange joint is expected to be pressure tight and therefore safe to operate. The objective in tightening the ring of bolts is to achieve uniform bolt tension as defined by a percentage of yield stress of the bolt.

Currently, the bolting method to be followed in such bolted flange connections is governed by ASME PCC-1 and requires a number of calculations, a calibrated torque tool, and at least two trained professionals, and after executing all the exacting tightening sequence and steps, often results in leaking joints because of the inherent inexactitude of the field torque-to-tension relationship encountered on individual bolts, and because after all the legacy method procedures are followed, it is not apparent that anything is different. That is, the correctly tightened bolt looks exactly like an incorrectly tightened bolt. The cross-talk between bolts from one side to the other (as one bolt is tightened the opposite bolt may loosen or tighten more depending on the flange condition, stiffness, etc.) often defeats the legacy method installers.

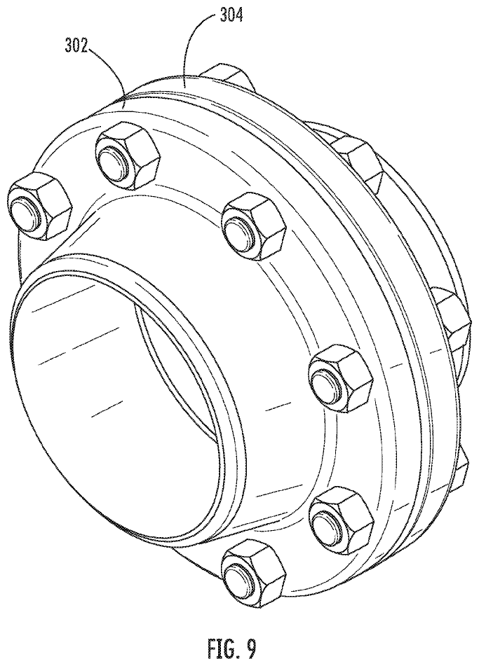

Embodiments of the disclosure includes methods and apparatus to facilitate loading a bolted flange connection, such that only a single pass of tightening the bolts is used. FIG. 9 depicts a bolted flange connection in an example embodiment. As shown in FIG. 9, a first flange 302 is secured to a second flange 304 using bolts or studs. Bolts, as used herein, is intended to cover bolts and studs, unless otherwise noted. Such joints are common in joining pipes, for example. A total of eight bolts and nuts are used in the example of FIG. 9. It is understood that any number of bolts/nuts may be used in the bolted flange connection, and use of eight bolts/nuts is an example only.

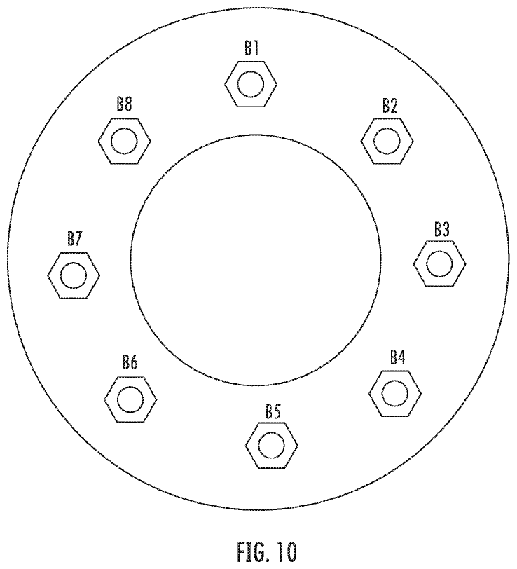

When securing the first flange 302 to the second flange 304, prior techniques would involve and installer loading each bolt to a certain load multiple times, and traversing the bolts in a cross-cross or star pattern. For example, referring to FIG. 10, a conventional installation technique may require loading the bolts B1-B8 in a pattern of B1, B5, B3, B7, B2, B6, B4, B8, at a load of, for example, 30% desired load. The pattern would then be repeated (or altered) with the installer loading the bolts to, for example, 70% desired load. The pattern would then be repeated (or altered) with the installer loading the bolts to 100% desired load. The pattern would then be repeated with the installer confirming the loading the bolts to 100% desired load. Repeatedly loading each bolt B1-B8 in a varying pattern to varying loads is time consuming and prone to error.

According to embodiments of the disclosure, bolts B1-B8 may be loaded, in sequence, to a load value in a single pass. The goal of loading the bolts B1-B8 is to have every bolt loaded to a predetermined bolt load value. For the sake of illustration, the predetermined bolt load value is 65 (unit-less for example purposes). To result in every bolt B1-B8 being loaded to the predetermined bolt load value, each bolt B1-B8 is loaded to an initial bolt load value. The loading may encompass tightening a nut on the bolt. For example, bolt B1 is loaded to an initial bolt load value of 100, bolt B2 is loaded to an initial bolt load value of 70, bolt B3 is loaded to an initial bolt load value of 70, bolt B4 is loaded to an initial bolt load value of 80, bolt B5 is loaded to an initial bolt load value of 100, bolt B6 is loaded to an initial bolt load value of 100, bolt B7 is loaded to an initial bolt load value of 70, and bolt B8 is loaded to an initial bolt toad value of 60. The numerical values are unit-less and are used as an example only. The bolts B1-B8 are loaded in a single pass, in sequence, in a single direction (e.g., clockwise or counterclockwise). Upon loading all the bolts B1-B8 to a respective initial bolt load value, each bolt B1-B8 will have a resultant bolt load value that meets the predetermined bolt load value.

The initial bolt load value referred to above may be identified in a variety of ways. In one embodiment, a direct tension indicating washer 100 (with or without a base washer 130) is assigned to each bolt B1-B8. Each direct tension indicating washer 100 is manufactured to emit the indicating material 117 at the outer diameter of the direct tension indicating washer 100 at a predetermined bolt load, which may be represented as bolt tension. It should be noted that detecting the load at each bolt B1-B8 may employ alternative methods, such as strain gauges, stud extension, load cells or even individually calibrated studs with torquing.

Referring hack the FIG. 10, if an installer is using a direct tension indicating washer 100 to determine bolt load, the installer would use a predetermined direct tension indicating washer 100 (with or without a base washer 130) at each bolt B1-B8. Referring to the example above, the direct tension indicating washer 100 used at bolt B1 would be manufactured to emit the indicating material 117 at the outer diameter of the direct tension indicating washer 100 at a predetermined bolt load value of 100. Direct tension indicating washers 100 would be tuned for the initial bolt load values of the remaining bolts B2-B8. All the installer needs to do is use the correct direct tension indicating washer 100 at each bolt B1-B8 and tighten the nut/bolt until the indicating material is emitted at the outer diameter of the direct tension indicating washer 100. This ensures that each bolt B1-B8 is loaded to the correct initial bolt load value, resulting in all the bolts B1-B8 having a resultant bolt load value meeting the predetermined bolt load value.

Embodiments of the invention allow installers to tighten bolts of a bolted flange connection in sequence (e.g. clockwise or counterclockwise) in a single pass and have the resultant bolt load value at each bolt meet a predetermined bolt load value. Each bolt is loaded to an initial bolt load value, which may be greater than, less than, or equal to the predetermined bolt load value. Each bolt load value may be established using a direct tension indicating washer 100, or through other techniques.

The direct tension indicating washers may be provided as a kit having N direct tension indicating washers for use with a bolted flange connection having N bolts. Each direct tension indicating washer may be numbered in sequence (from 1 to N) so that an installer only needs to place the direct tension indicating washers on the bolts of the bolted flange connection, in the labeled sequence. Each nut is then tightened, in the sequence from 1 to N, until the indicating material is emitted at the outer diameter of the direct tension indicating washer (e.g., the initial bolt load value). Once all the bolts are loaded to the initial bolt load value, the resultant bolt load value at each bolt will meet the predetermined bolt load value.

This tightening method will save field bolting crews about three-quarters of the time they are compelled to take now, with equal or superior results in uniformity of bolt tension, and therefore in joint integrity, and when finished the crew will know they have tightened every bolt, due to the visible indicating of the indicating material at the outer diameter of the direct tension indicating washer 100, and not missed one.

With respect to the bolt load meeting the initial bolt load value and the resultant bolt load value meeting the predetermined bolt load value, it is understood that this relationship does not require exact equivalence. The bolt load at an individual bolt may be within +/−5% of the initial bolt load value and still be considered to meet the initial bolt load value. Furthermore, the resultant bolt load value of a bolt may be within +/−5% of the predetermined bolt load value and still be considered to meet the predetermined bolt load value.

While exemplary embodiments have been shown and described, various modifications and substitutions may be made thereto without departing from the spirit and scope of the invention. Accordingly, it is to be understood that the present invention has been described by way of illustration and not limitation.

What is claimed is:

1. A method of loading bolts of a bolted flange connection, the method comprising:
obtaining an initial bolt load value for each of the bolts;
loading each of the bolts, in sequence, to a respective initial bolt load value;
wherein each of the bolts achieves a resultant bolt load value that meets a predetermined bolt load value.

2. The method of claim 1 wherein, loading each of the bolts, in sequence, to the respective initial bolt load value comprises using a direct tension indicating washer.

3. The method of claim 2 wherein, loading each of the bolts, in sequence, to the respective initial bolt load value comprises tightening a nut until an indicating material is visible at an outer diameter of the direct tension indicating washer.

4. The method of claim 2 further comprising using a base washer with the direct tension indicating washer.

5. The method of claim 1 wherein, loading each of the bolts, in sequence, to the respective initial bolt load value comprises loading each bolt in sequence in a clockwise or a counterclockwise pattern.

6. A kit for securing a bolted flange connection staving N bolts, the kit comprising:
N direct tension indicating washers;
each of the N direct tension indicating washers being configured to indicate an initial bolt load value;
wherein upon loading each of the N bolts to a respective initial bolt load value, each of the bolts achieves a resultant bolt load value that meets a predetermined bolt load value.

7. The kit of claim 6 wherein the direct tension indicating washers are numbered from 1 to N, respectively.

8. The kit of claim 6 further comprising at least N base washers.
